(19) United States
(12) Patent Application Publication
(10) Pub. No.: US 2023/0010196 A1
(43) Pub. Date: Jan. 12, 2023

(54) PICKING SYSTEM

(71) Applicant: JOHNAN Corporation, Uji-shi (JP)

(72) Inventors: Kozo MORIYAMA, Uji-shi (JP); Truong Gia VU, Uji-shi (JP); Xiang RUAN, Kusatsu-city (JP); Tomohiro NAKAGAWA, Kusatsu-city (JP); Taro WATASUE, Kusatsu-city (JP); Hironobu SAKAGUCHI, Kusatsu-city (JP)

(73) Assignee: JOHNAN Corporation, Uji-shi (JP)

(21) Appl. No.: 17/861,826

(22) Filed: Jul. 11, 2022

(30) Foreign Application Priority Data
Jul. 12, 2021 (JP) 2021-115254

(51) Int. Cl. G06T 7/73; B25J 9/16; G06T 17/10; G06V 10/764

(52) U.S. Cl. CPC G06T 7/75; B25J 9/1612; G06T 17/10; G06V 10/764; G06T 2210/56; G06T 2207/30164; G06T 2207/10028; G06T 2207/10024

(57) ABSTRACT

A picking system is provided, which is capable of picking up an object even when the object is not registered in advance. The picking system includes: a picking device holding the object; an RGB-D camera acquiring three-dimensional point cloud data of the object to be picked up by the picking device; and a control device controlling the picking device based on a detection result by the RGB-D camera. The control device generates a geometric model of the object by combining simple geometric primitives while referring to the three-dimensional point cloud data, and calculates a holding position of the object for the picking device based on the geometric model.

### TECHNICAL FIELD

The present invention relates to a picking system.

### BACKGROUND ART

Conventionally, a picking system is known, which includes a picking device that holds a workpiece (an object) and a control device that controls the picking device (for example, see Patent Document 1).

The picking system in Patent Document 1 is configured to measure the three-dimensional shape of a workpiece using a distance sensor and compare a measurement result to a 3D CAD model of the workpiece, so that the position and the posture of the workpiece is recognized.

### PRIOR ART DOCUMENT

### Patent Document

[Patent Document 1] JP 2010-069542 A

### SUMMARY OF THE INVENTION

### Problem to Be Solved by the Invention

However, in the conventional picking system as described above, it is necessary to register the 3D CAD model in advance so as to recognize the workpiece. In this regard, there is still a room for improvement.

The present invention was made in consideration of the above problem, an object of which is to provide a picking system capable of picking up an object even when the object is not registered in advance.

### Means for Solving the Problem

A picking system of the present invention includes: a picking device holding an object; a distance sensor acquiring three-dimensional point cloud data of the object to be picked up by the picking device; and a control device controlling the picking device based on a detection result by the distance sensor. The control device generates a geometric model of the object by combining simple geometric primitives while referring to the three-dimensional point cloud data. Also, the control device calculates a holding position of the object for the picking device based on the geometric model.

In this way, by generating the geometric model of the object and calculating the holding position, it is possible to pick up the object even when the object is not registered in advance.

The above-described picking system may further include an image sensor acquiring image data of the object to be picked up by the picking device. Geometric models of a plurality of types of objects and respective holding parts of the geometric models may be registered in advance in the control device. The control device may identify the type of the object using the image data, and also may calculate the holding position of the object for the picking device taking into account a corresponding holding part of the registered geometric model of the identified type of the object.

### Effects of the Invention

With the picking system of the present invention, it is possible to pick up an object even when such an object is not registered in advance.

### BRIEF DESCRIPTION OF THE DRAWINGS

FIG. 1 is a block diagram illustrating a schematic configuration of a picking system according to an embodiment.

FIG. 2 is a diagram explaining an example of a geometric model registered in a control device in the picking system of FIG. 1.

FIG. 3 is a flowchart explaining operations to determine a holding position in the picking system of the embodiment.

### MODE FOR CARRYING OUT THE INVENTION

Hereinafter, an embodiment of the present invention will be described.

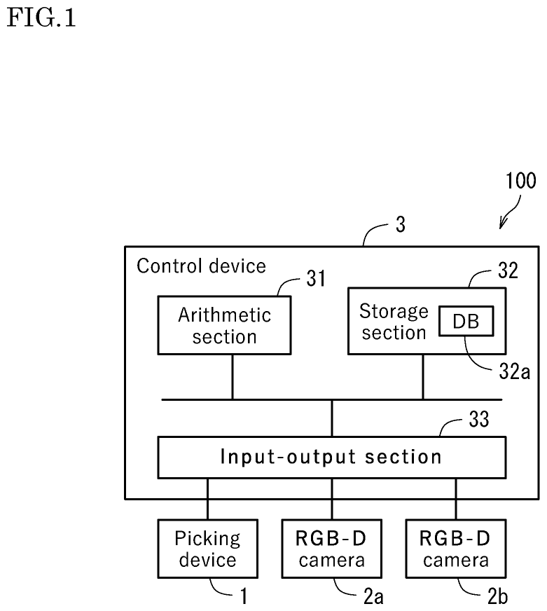

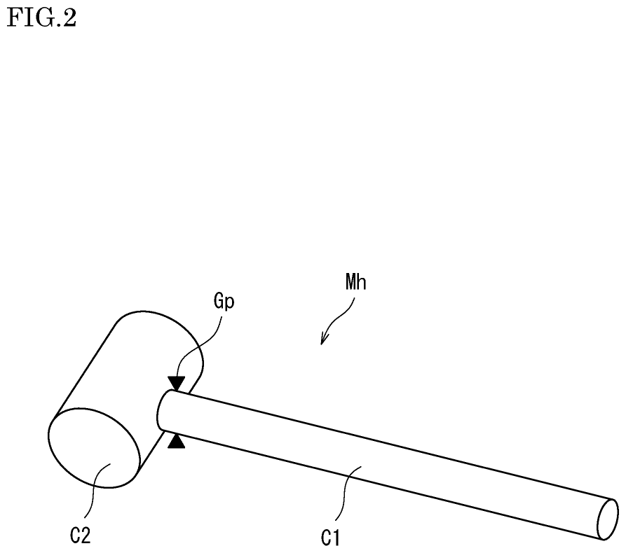

A configuration of a picking system 100 according to an embodiment of the present invention is described with reference to FIGS. 1 and 2.

The picking system 100 is configured to pick up an object (not shown) so as to perform, for example, automatic sorting and/or automatic transport of the object. The picking system 100 is provided to pick up one object (object to be held) located in a predetermined region. As shown in FIG. 1, the picking system 100 includes: a picking device 1; RGB-D cameras 2a and 2b; and a control device 3.

The picking device 1 is provided to hold the object located in the predetermined region. For example, the picking device 1 includes a robot arm and a hand, which are not shown in the Drawings. The hand is provided at a tip of the robot arm so as to hold the object. The robot arm can control the position and the posture of the hand by moving the hand.

The RGB-D cameras 2a and 2b each take an image of the object located in the predetermined region so as to acquire an RGB-D image. The RGB-D image includes an RGB image (color image) and a depth image, and thus has information on each pixel depth of the RGB image. Also, the RGB-D cameras 2a and 2b can convert an RGB-D image into a three-dimensional point cloud data. Here, the RGB image is an example of “image data” of the present invention. Furthermore, the RGB-D camera 2a is an example of a “distance sensor” and/or an “image sensor” of the present invention, and the RGB-D camera 2b is also an example of a “distance sensor” and/or an “image sensor” of the present invention.

The RGB-D cameras 2a and 2b each take an image of the object from different angles. For example, the RGB-D camera 2a takes an image of an object located in a predetermined region from one side while the RGB-D camera 2b takes an image of the object from the other side. That is, the two RGB-D cameras 2a and 2b are provided in order to prevent the outer shape of the object located in the predetermined region from entering the blind spot.

The control device 3 controls the picking device 1 based on imaging results by the RGB-D cameras 2a and 2b. The control device 3 includes an arithmetic section 31, a storage section 32, and an input-output section 33. The arithmetic section 31 executes arithmetic processing based on a program and the like stored in the storage section 32. In the storage section 32, the program and the like to control operations of the picking device 1 are stored. The input-output section 33 is connected to the picking device 1, the RGB-D cameras 2a and 2b, and the like. A control signal to control the operations of the picking device 1 is output from the input-output section 33, and also the imaging results by the RGB-D cameras 2a and 2b are input into the input-output section 33.

Then, the control device 3 calculates a holding position of the object for the picking device 1 based on the imaging results by the RGB-D cameras 2a and 2b. The calculation of the holding position allows appropriate picking-up of the object. In the storage section 32 are stored: a program to calculate the holding position of the object for the picking device 1; a DB (database) 32a for the program; and a learned model (not shown) that will be described later.

In the DB 32a are stored, in association with one another, an ID indicating the type of the object, a geometric model of the object, and a holding part of the geometric model. That is, in the DB 32a, the type ID of the object, the geometric model and the holding part are respectively set as columns (items), and a plurality of records are stored. The records are registered in the DB 32a in advance by, for example, a user. Also, the geometric model of the object schematically and three-dimensionally represents the outer shape of the object, which is generated by combining multiple simple geometric primitives with each other. The simple geometric primitives include, for example: a cube; a sphere; a cylinder; and a cone, whose orientation and size are variable.

As a specific example, when the type of the object is a “hammer”, a geometric model Mh is generated using two cylindrical objects C1 and C2, and a holding part Gp of the geometric model Mh is designated, as shown in FIG. 2. The user registers the type ID of the object, generates the geometric model Mh, and designates the holding part Gp. The holding part Gp is a part of the object that is appropriate to be held by the picking device 1. As one example, the centroid position of the geometric model Mh may be set as the holding part Gp. As to a plurality of objects, the records as exemplarily described above are registered in advance.

As shown in FIG. 1, the information on the position and the posture of the RGB-D cameras 2a and 2b (i.e. external parameters) is stored in advance in the control device 3. The control device 3 integrates three-dimensional point cloud data obtained by the RGB-D camera 2a with the three-dimensional point cloud data obtained by the RGB-D camera 2b. Then, the control device 3 refers to the integrated three-dimensional point cloud data of the object and generates a geometric model of the object by combining the simple geometric primitives. The simple geometric primitives include, for example: a cube; a sphere; a cylinder; and a cone, whose orientation and size are variable. That is, the geometric model, which is approximated by the three-dimensional point cloud data, is generated by combining the simple geometric primitives while fitting the simple geometric primitives to the three-dimensional point cloud data. This geometric model schematically and three-dimensionally represents the outer shape of the object, which is generated by the multiple simple geometric primitives.

The control device 3 also identifies the type of the object using RGB images (i.e. two-dimensional image data) obtained by the RGB-D cameras 2a and 2b. This identification of the type of the object is performed using the learned model (publicly known) stored in the storage section 32. Then, when the control device 3 successfully identifies the type of the object and furthermore when the identified type of the object is registered in the DB 32a, the control device 3 calculates the holding position of the object based on the generated geometric model taking into account the holding part of the geometric model of the object registered in the DB 32a. On the other hand, when the control device 3 unsuccessfully identifies the type of the object or when the identified type of the object is not registered in the DB 32a, the control device 3 calculates the holding position of the object based on the generated geometric model.

Also, the control device 3 controls the picking device 1 such that the picking device 1 holds the object by the calculated holding position of the object. That is, after operations to identify the holding position as described below are completed, the control device 3 causes the picking device 1 to perform picking operations by the holding position of the object, which is calculated by the operations to identify the holding position. In other words, the control device 3 performs the operations to identify the holding position before the picking operations by the picking device 1 is started. Thus, the holding position of the object at the time of picking operations is adjusted.

### Operations to Identify Holding Position in Picking System

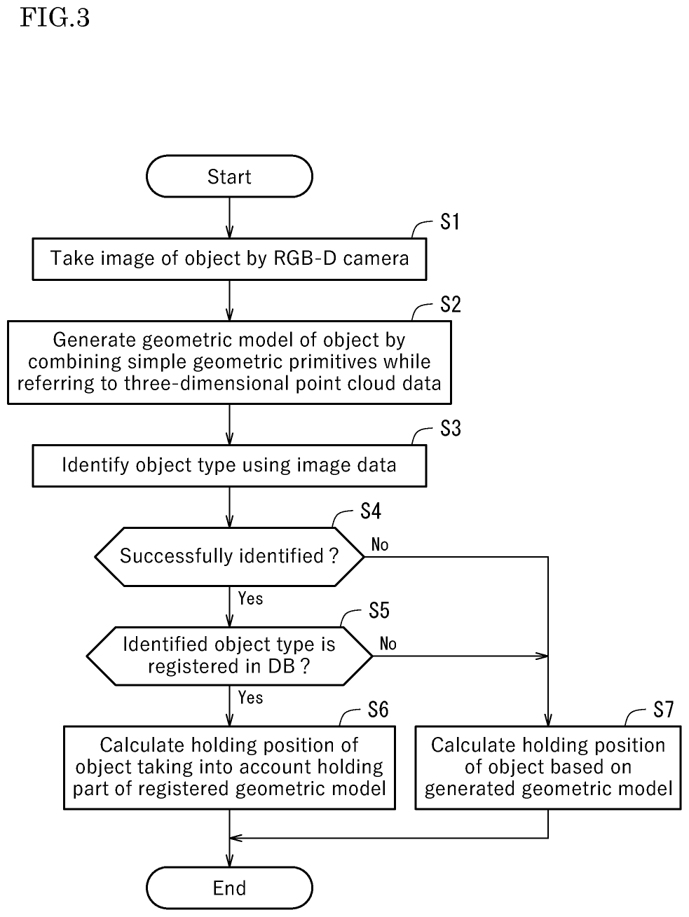

Here, a description will be given on the operations to identify the holding position in the picking system 100 according to this embodiment referring to FIG. 3. The operations to identify the holding position are performed before the picking operations of the object located in the predetermined region is started by the picking device 1. The respective steps described below are performed by the control device 3.

First, in step S1 shown in FIG. 3, the imaging results by the RGB-D cameras 2a and 2b are acquired. Specifically, the RGB-D cameras 2a and 2b take images of the object located in the predetermined region, and the imaging results are input into the input-output section 33. The imaging result includes the RGB image and the three-dimensional point cloud data. Then, the three-dimensional point cloud data from the RGB-D camera 2a and the three-dimensional point cloud data from the RGB-D camera 2b are integrated with each other.

Next in step S2, the geometric model of the object is generated by combining the simple geometric primitives while referring to the integrated three-dimensional point cloud data. That is, the geometric model, which is approximated by the three-dimensional point cloud data, is generated by combining the simple geometric primitives while fitting the simple geometric primitives to the three-dimensional point cloud data. It is possible to improve the accuracy of the geometric model not only by adding the simple geometric primitive, but also by removing the simple geometric primitive. Thus, the geometric model is generated by adding or removing the simple geometric primitive(s) whose orientation and size are appropriately adjustable.

Next in step S3, the type of the object is identified using the RGB images (two-dimensional image data) from the RGB-D cameras 2a and 2b. This identification of the type of the object is performed using the learned model (publicly known). For example, when the RGB image is input into the learned model, the type of the object on the image is estimated and also the certainty of the estimation result is calculated.

Next in step S4, it is determined whether the identification of the type of the object using the RGB images has been successfully performed. For example, when the certainty of the estimated result calculated in step S3 is not less than a predetermined threshold value, it is determined that the identification has been successfully performed. When it is determined that the identification has been successfully performed, the procedure advances to step S5. On the other hand, when it is determined that the identification has been unsuccessfully performed, the procedure advances to step S7.

Next in step S5, it is determined whether the identified type of the object is registered in the DB 32a. When it is determined that the identified type of the object is registered in the DB 32a, the procedure advances to step S6. On the other hand, when it is determined that the identified type of the object is not registered in the DB 32a, the procedure advances to step S7.

Next in step S6, the holding position of the object is calculated based on the generated geometric model taking into account the holding part of the geometric model of the object registered in the DB 32a. For example, the holding position of the object is calculated by comparing the geometric model of the object that is generated in step S2 to the geometric model of the object that is registered in the DB 32a so as to apply the holding part of the registered geometric model of the object to the generated geometric model of the object. In other words, the holding position of the object is calculated by applying the holding part designated by the user in advance according to the type of the object to the generated geometric model. As a specific example, when the type of the object is identified as a “hammer” using the RGB images, and furthermore when the “hammer” is registered in the DB 32a, the holding position of the object is calculated based on the geometric model generated by referring to the three-dimensional point cloud data of the object taking into account the holding part Gp of the registered geometric model Mh (see FIG. 2).

Also in step S7, the holding position of the object is calculated based on the generated geometric model. For example, the centroid position in the case where the density of the geometric model of the object generated in step S2 is assumed to be uniform may be calculated as the holding position of the object. Also, the center position of the largest one of the simple geometric primitives constituting the geometric model of the object generated in step S2 may be calculated as the holding position of the object.

### Effects

In this embodiment as described above, the geometric model of the object is generated by combining the simple geometric primitives while referring to the three-dimensional point cloud data. Also, the holding position of the object for the picking device 1 is calculated based on the generated geometric model. Thus, it is possible to pick up the object even when it is not registered in advance. Specifically, when the identification of the type of the object has been unsuccessfully performed or when the identified type of the object is not registered in the DB 32a, it is also possible to appropriately pick up the object by calculating the holding position based on the geometric model generated by referring to the three-dimensional point cloud data.

Also in this embodiment, when the type of the object is registered in advance, it is possible to improve the accuracy of picking-up by calculating the holding position of the object taking into account the holding part of the registered geometric model of the object.

Also in this embodiment, it is possible to easily identify the type of the object by identifying the type of the object using the RGB images (two-dimensional image data).

### Other Embodiments

The foregoing embodiment is to be considered in all respects as illustrative and not limiting. The scope of the invention is indicated by the appended claims rather than by the foregoing description, and all modifications and changes that come within the meaning and range of equivalency of the claims are intended to be embraced therein.

For example, in the above-described embodiment, the two RGB-D cameras 2a and 2b are provided. However, the number of the RGB-D cameras to be provided is not particularly limited. For example, only one RGB-D camera may be provided. In this case, the RGB-D camera may be attached to the robot arm. In this way, it is possible to capture the object from multiple perspectives by taking images of the object by the RGB-D camera that is being moved with the robot arm.

Also in the above-described embodiment, the identification of the type of the object is performed using the RGB images (two-dimensional image data). However, the present invention is not limited thereto. The identification of the type of the object using the RGB images is not particularly needed to be performed. In this case, after the geometric model of the object is generated by combining the simple geometric primitives by referring to the three-dimensional point cloud data, the holding position of the object may be calculated based on the generated geometric model. That is, the steps S3 to S6 in the above-described flowchart are not set, and the procedure may advance to step S7 after the step S2. Furthermore, since the RGB images are not required in this case, a distance sensor may be provided in place of the RGB-D camera in order to acquire the three-dimensional point cloud data of the object.

Also in the above-described embodiment, the centroid position of the geometric model Mh is set as the holding part Gp. However, the present invention is not limited thereto. The center position of the largest one of the simple geometric primitives constituting the geometric model may be set as the holding part. In this way, the holding part may be freely set by the user.

Also in the above-described embodiment, the three-dimensional point cloud data is input into the control device 3 from the RGB-D cameras 2a and 2b. However, the present invention is not limited thereto. The control device may calculate the three-dimensional point cloud data based on the RGB-D images that are input from an RGB-D camera.

Also in each of the RGB-D cameras 2a and 2b in the above-described embodiment, an RGB image acquisition section that acquires RGB images and a depth image acquisition section that acquires depth images may be integrally provided in one case, or may be separately provided in respective cases.

### Clauses

A method for identifying a holding position using a picking system, the picking system including: a picking device holding an object; a distance sensor acquiring three-dimensional point cloud data of the object to be picked up by the picking device; and a control device controlling the picking device based on a detection result by the distance sensor,
the method comprising:
a step of acquiring, using the distance sensor, the three-dimensional point cloud data of the object to be picked up by the picking device;
a step of generating, by the control device, a geometric model of the object by combining simple geometric primitives while referring to the three-dimensional point cloud data; and
a step of calculating, by the control device, the holding position of the object for the picking device based on the geometric model.

The method for identifying a holding position as described above, wherein the picking system further includes an image sensor that acquires image data of the object to be picked up by the picking device, and geometric models of a plurality of types of objects and respective holding parts of the geometric models are registered in advance in the control device,
the method further comprising:
a step of acquiring, using the image sensor, the image data of the object to be picked up by the picking device;
a step of identifying, by the control device, a type of the object using the image data; and
a step of calculating, by the control device, the holding position of the object for the picking device taking into account a corresponding holding part of the registered geometric model of the identified type of the object.

A picking method comprising the above-described method for identifying a holding position.

A program to cause a computer to execute the respective steps of the above-described method for identifying a holding position.

### Industrial Applicability

The present invention is applicable to a picking system including a picking device that holds an object and a control device that controls the picking device.

### DESCRIPTION OF REFERENCE NUMERALS

1 Picking device

2a RGB-D camera (distance sensor, image sensor)

2b RGB-D camera (distance sensor, image sensor)

3 Control device

100 Picking system

What is claimed is:

1. A picking system comprising:
a picking device holding an object;
a distance sensor acquiring three-dimensional point cloud data of the object to be picked up by the picking device; and
a control device controlling the picking device based on a detection result by the distance sensor, wherein
the control device generates a geometric model of the object by combining simple geometric primitives while referring to the three-dimensional point cloud data, and
the control device calculates a holding position of the object for the picking device based on the geometric model.

2. The picking system according to claim 1, further comprising an image sensor acquiring image data of the object to be picked up by the picking device, wherein
geometric models of a plurality of types of objects and respective holding parts of the geometric models are registered in advance in the control device,
the control device identifies a type of the object using the image data, and
the control device calculates the holding position of the object for the picking device taking into account a corresponding holding part of the registered geometric model of the identified type of the object.
